(19) United States
(12) Patent Application Publication
(10) Pub. No.: US 2025/0062654 A1
(43) Pub. Date: Feb. 20, 2025

(54) Cooling Ring for a Winding Head of an Active Part of a Drive Machine

(71) Applicant: Bayerische Motoren Werke Aktiengesellschaft, Muenchen (DE)

(72) Inventors: Andrew BRODIE, Muenchen (DE); Aleksander JERIN, Puchheim (DE)

(21) Appl. No.: 18/723,756

(22) PCT Filed: Jan. 23, 2023
(86) PCT No.: PCT/EP2023/051496

§ 371 Date: Jun. 24, 2024

(30) Foreign Application Priority Data
Feb. 24, 2022 (DE) 10 2022 104 358.4

(51) Int. Cl. H02K 5/20; H02K 3/12; H02K 9/22; H02K 15/12; H02K 15/14

(52) U.S. Cl. CPC H02K 5/20; H02K 3/12; H02K 9/225; H02K 15/12; H02K 15/14; H02K 2215/00

(57) ABSTRACT

A cooling ring for a winding head of an active part of an electric drive machine of a motor vehicle, includes a cavity cooling volume, which surrounds the winding head, and an enveloping plastic component which forms a winding head cooling channel that seals the cooling volume against the winding head and against an environment of the winding head. Also disclose are an active part cooling arrangement and a method for producing a cooling ring.

### BACKGROUND AND SUMMARY

The invention relates to a cooling ring for a winding head of an active part of an electric drive machine, and to an active part cooling assembly. The invention furthermore relates to a method for producing a cooling ring.

The peak output of an electric drive machine is typically limited by the temperature of its active parts (rotor and stator). If the peak output of an electric drive machine is limited by the stator, this is often due to the temperature of the winding heads. The latter cause a large proportion of the thermal losses in the machine, and are not particularly well cooled in classic cooling concepts. If an electric drive machine is not directly cooled by air, a cooling unit is in most instances located in the housing. There are various approaches to improving cooling of the winding heads in this case: (1) without any further modification, the heat is dissipated from the winding heads via the copper to the stator material, and from the stator material to the housing. (2) The winding heads are fully potted using an insulating plastics material in such a way that its direct path is between the winding heads and the housing, part of the heat can follow this direct path. (3) The winding heads can be potted to a specific thickness using an insulating plastics material, and a separate hollow casting from plastics material can be attached, for example by an adhesively bonded connection. This separate hollow casting is passed through by a flow of a cooling liquid. (4) Concepts with direct contact between the coolant and the winding head. The winding heads are sprayed with oil, or surrounded by a flow of oil.

A further cooling concept is known from DE 10 2020 206 333 A1. Here, a first, inner wall is attached to the winding heads, and brought into the shape of the winding heads by blow-molding, for example. Moreover, a second, outer wall is attached, as a result of which a cavity for a cooling liquid is created between the outer and the inner wall. There must be a fixed connection (adhesively bonded, for example) between the two parts (inner and outer wall) in order to prevent that liquid leaks from the cavity and thus damages the stator. The inner and the outer wall have to be produced and attached separately from one another. This requires a high degree of complexity in the production and assembly of the electric machine, and causes possible types of failure during assembly or operation.

Against this background, it is an object of the invention to improve cooling of an active part of an electric drive machine of a motor vehicle.

The present disclosure, by way of its features, determines a subject matter that achieves this object. The present disclosure also relates to advantageous refinements of the invention.

Disclosed according to one aspect is a cooling ring for a winding head, in particular for an annular winding head assembly, of an active part, in particular of a stator or of a rotor, of an electric drive machine of a motor vehicle, having: (a) an in particular circular-annular cavity cooling volume which encloses the winding head; (b) a plastics material casing component which forms a winding head cooling duct that seals the cooling volume, in particular on an entire cooling ring circumference, in relation to the winding head, in particular the windings of the winding head, and in relation to an environment of the winding head, in particular a winding head space.

Owing to the fact that a single plastics material casing component delimits the entire winding head cooling duct, the latter is much more robust in terms of failure during operation, for example at a joint, because joints are not required in the cooling ring according to the invention.

According to one embodiment, the plastics material casing component forms the entire wall of the winding head cooling duct, in particular in relation to the winding head as well as in relation to an environment of the winding head. In this way, the coolant for an entire winding head can be formed by the single plastics material casing component.

According to one embodiment, the plastics material casing component is formed integrally (i.e. presently in particular: originally molded as a single component, in particular in one process step, presently rotational molding), in particular by a rotational molding process. Such a plastics material casing component is much easier to produce in a reliable process, and is moreover lighter and more robust.

Disclosed according to a further aspect is an active part cooling assembly, in particular a stator or rotor cooling assembly, for an electric drive machine of a motor vehicle, having: (A) an active part having an active part core and on both sides of the active part core in each case one winding head which extends so as to proceed from the active part core; (B) a cooling ring according to one embodiment of the invention on at least one, in particular both, of the winding heads.

According to one embodiment, the active part cooling assembly has a heat pipe which extends in the active part core and in the cooling ring and for heat transmission is thermally connected to both. In this way, the heat transmission from the active part core toward the cooling duct can be enhanced.

Disclosed according to a further aspect is a method for producing a cooling ring for a winding head, in particular for an annular winding head assembly, of an active part, in particular of a stator or of a rotor, of an electric drive machine of a motor vehicle, comprising at least the following method steps which can be carried out in the sequence stated or in any other expert sequence: (i) producing a wall of a plastics material casing component, which delimits a cavity cooling volume that surrounds the winding head, by a rotational molding method.

The invention is based, inter alia, on the concept of attaching a cooling ring made from a single component to the winding heads. This enables the production process of rotational molding, which is applied to the winding heads per se.

In this way, the cooling ring on each winding head is a single part which is attached directly to the winding head in such a way that no connection between a plurality of parts is required for forming the cooling duct. Rotational molding enables the production in a few steps. Arbitrary shapes can be produced, fewer parts used, and costs saved.

Finally, it can be achieved that liquid cooling is no longer required in the stator housing, which can save an enormous amount of radial installation space.

According to one embodiment, the cooling volume contains at least one bounding geometry, in particular a bounding volume, of the winding head in terms of a circumferential direction and a longitudinal axis of the active part. A sufficient coolant flow which is sufficiently turbulent is achieved in this way.

According to one embodiment, the cooling volume extends beyond the overall extent of the winding head by part of this extent; in the radial direction of the active part toward the inside and/or the outside, in particular by 5% or 10% or 25%, and/or in the axial direction of the active part away from the stator core, in particular by 25% or 50% or 100%. A required amount of heat transmission can be ensured by a projection which is designed for the specific application.

According to one embodiment, a stator core-proximal wall of the cooling ring is formed on an appendage of the windings of the winding head on an active part core. A positive thermal transfer from the active part core to the winding head and/or a tight delimitation of the cooling duct are/is achieved in this way.

According to one embodiment, the active part core-proximal wall of the cooling ring for heat transmission is thermally connected to an axial lateral wall of the active part core. This ensures a positive thermal transfer to the wall of the cooling ring. According to one embodiment, the wall is formed by a thermoplastic and/or a thermosetting plastics material.

According to one embodiment, attaching a production mold, which has a groove in the shape of an envisaged external contour of the cooling ring and contains an original wall material, in particular a curable plastics material powder (i.e. has received the latter in the groove), over the winding head to an axial lateral wall of a core of the active part is performed. In this way, the cooling ring can be integrally produced directly on site.

According to one embodiment, the production mold has a seal, for example of rubber, for establishing the original wall material in the groove, and/or is shaped in such a manner that the original wall material used for rotational molding does not flow out of the groove. It is ensured in this way that there is sufficient original wall material in the groove for rotational molding, and no original wall material can flow into grooves of the electric drive machine.

According to one embodiment, the production mold has a temperature control system by way of which the production mold can be temperature-controlled, in particular heated and cooled, before, during and/or after rotational molding. In particular, ducts for heating coils of an electric heating and/or a fluid-based temperature control can be integrated in the mold, the thickness of the external wall of the cooling ring being able to be controlled in this way.

According to one embodiment, the temperature control system of the production mold is specified only for cooling, for example by water ducts. Potentially required heating of the production mold, in particular of the original wall material disposed therein, is implemented according to one embodiment in that the rotational molding is carried out in an oven, or while using another external heat source for heating and/or pre-heating the production mold.

According to one embodiment with local temperature changes, locally different wall thicknesses of the wall can be formed when cooling by water ducts, because the original wall material takes different times to cure in this instance.

According to one embodiment, the original wall material is a thermoplastic material and is heated in the production mold before and/or during rotational molding. In the process, the entire active part assembly is rotated, as a result of which the wall of the cooling ring is formed integrally from the heated original wall material.

According to one embodiment, the original wall material is a thermosetting plastics material, the components thereof being activated before rotational molding in such a way that curing takes places during rotation, the wall of the cooling ring thus being formed integrally from the heated original wall material.

According to one embodiment, the production mold is cooled and continues to rotate, or is rotated again, when the wall has already been formed. The wall thickness of the wall can be adjusted as a result.

According to one embodiment, the production mold is removed after rotational molding. The cooling ring is thus completely formed.

According to one embodiment, the production mold attached to the active part, conjointly with the active part, is rotated successively or simultaneously about two or more rotation axes so as to completely form the external contour and thus the wall by the acting centrifugal forces.

In order to connect the cavity cooling volume to a supply line and a discharge line of cooling fluid, corresponding supply and discharge lines can already be pre-assembled and insert molded during rotational molding; boring of supply and discharge line holes, into which the corresponding lines can subsequently be introduced and fixed, can also be provided. The cooling fluid can be supplied radially from the outside, for example, or axially from the stator housing if the active part is a stator. If the active part is a rotor, the supply can be performed radially from the inside, for example, or axially from a hollow rotor shaft.

Further advantages and potential applications of the invention are derived from the description hereunder in conjunction with the figures.

### BRIEF DESCRIPTION OF THE DRAWINGS

FIG. 1 shows an intermediate stage in a production method according to an exemplary embodiment of the present disclosure, in a schematic lateral view;

FIG. 2 shows a further intermediate stage of the exemplary production method from FIG. 1, in a schematic lateral view;

FIG. 3 shows an active part cooling assembly having two cooling rings according to an exemplary embodiment of the present disclosure, the latter having been produced by the method according to FIGS. 1 and 2, in a schematic lateral view; and

FIG. 4 shows a further active part cooling assembly according to a further exemplary embodiment of the present disclosure, having heat pipes, in a schematic lateral view.

### DETAILED DESCRIPTION OF THE DRAWINGS

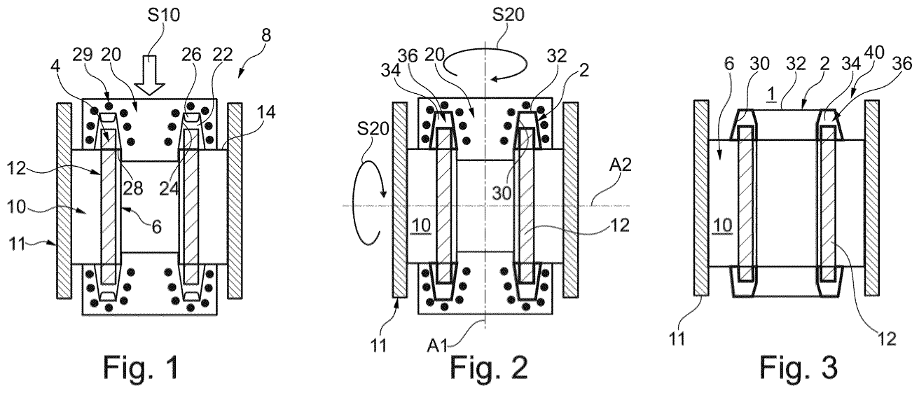

A method for producing by rotational molding a cooling ring 2 for a winding head 4 of an active part 6 of an electric drive machine 8 of a motor vehicle is explained by means of FIGS. 1 to 3. The active part 6 is presently the stator of the electric drive machine 8 and has an active part core 10 (=stator core) which is fixedly mounted in a motor housing 11 and through which windings 12 run in the direction of the longitudinal axis. The continuations of the windings 12 form on both sides of the active part core 10 in each case one winding head assembly, the latter herein also being referred to as winding head 4 for short.

Shown in FIG. 1 is the attaching S10 of a production mold 20 over the winding head 4 to an axial lateral wall 14 of the active part core 10. The production mold 20 has a groove 22 in the shape of an envisaged external contour 24 of the cooling ring 2, in which is received an original wall material 26, presently as a plastics material powder. The production mold 20 has a seal 28 for sealing the groove 22 and thus for establishing the original wall material 26 in the groove 22. Moreover, the production mold 20 has a temperature control system 29 having temperature-control water ducts by which the production mold 22 can be temperature-controlled before, during and/or after rotational molding.

The forming step in the production S20 of a wall 30 of a plastics material casing component 32 by rotational molding, i.e. by rotating the entire assembly illustrated about one or a plurality of rotation axes, is illustrated in FIG. 2. Rotating is presently performed about a rotation axis A1, presently the rotation axis of the electric drive machine 8, and about a rotation axis A2, presently an axis that runs perpendicularly through the longitudinal axis A1 in the longitudinal axial center of the stator core. In this way, the wall 30 can presently be completely formed in the case of specific wall geometries.

Depending on the wall 30 to be formed, a third rotation axis and/or agitating of the entire production assembly can also be provided presently and/or in other exemplary embodiments. The different rotations and/or one-off or multiple agitating can be implemented successively or simultaneously, thus in a mutually superimposed manner.

The wall 30 herein is formed in such a way that the plastics material casing component 32 has the external contour 24 and as a hollow component delimits a cavity cooling volume 34 which surrounds the winding head 4. In this way, the cavity cooling volume 34 is electrically separated by the wall 30, and in terms of a cooling fluid delimited in relation to the winding head 4 and the environment 1 of the plastics material casing component 32, correspondingly forming a winding head cooling duct 36. A wall thickness of the wall 30 can be adjusted by cooling the production mold 20.

The individual method steps of the production method of FIGS. 1 to 3 are described hereunder.

S10: First, the production mold 20 is attached to the end of the windings 21, i.e. the winding heads 4. The production mold 20 is presently centered by bearing on an internal circumference of the stator core 10. Moreover, the production mold is equipped with a seal 28 (presently of rubber) in such a way that the original wall material 26 used for rotational molding cannot flow into grooves of the electric drive machine 8. This is because the electrical conductors are situated in the grooves of the stator core. For technical reasons, the conductors do not terminate flush with the internal radius of the stator core, i.e. there is still some “air” in the stator core grooves; without the seal 28, the latter would be undesirably filled by the rotational molding.

S20: (a) If the original wall material 26 used for rotational molding is a thermoplastic material, it is heated by the temperature control system 29, and the entire assembly is rotated, as a result of which the cooling ring is formed. (b) If the original wall material 26 is a thermosetting plastics material, the latter does not have to be heated and it is sufficient for the entire assembly to be rotated.

The original wall material 26 is subsequently cooled, and the assembly is rotated again, as a result of which the wall thickness of the wall 30 of the plastics material casing component 32 is adjusted.

Lastly, the production mold 20 is removed.

The cooling rings 2 are connected directly to the respective winding head 4 and in the cavity cooling volume 34 can in each case be passed through by a flow of a cooling medium. For this purpose, a supply and discharge line for cooling fluid, which is not illustrated, is provided in each cooling ring 2.

As a result of the rotational molding, the original wall material also wets the winding head, or the individual wires of the latter (in addition to the external contour of the groove of the production mold). As a result, the winding head is wetted by a thin layer of plastics material. This avoids direct contact between the electrical conductors and the coolant (risk of the current flowing by way of the water).

Therefore, there is no direct contact between the cooling medium and the winding head 4 when a flow passes through, so that the cooling medium can be freely chosen (e.g. even an electrically conducting coolant such as water) and damage to the windings is prevented. The plastics material casing component 32 thus forms the cooling ring 2 which is illustrated after removal of the production mold in FIG. 3.

Due to a potentially required dimensional stability, it can presently be provided that the cooling ports are already pre-produced and insert-molded in the production mold. For example, the cooling port can be embodied like a short piece of pipe to which a hose for the supply of coolant can later be attached. In this instance, the coolant port parts are for example attached to the provided location in the interior of the production mold, and conjointly molded in the rotational method. The molded holes in the cooling port piece can then be pierced after completion of the rotational molding.

Stator cooling in the motor housing 11 can either be replaced by a cooling ring cooling of this type, and installation space thus be saved; or the cooling ring cooling is used additionally in order to enable a higher permanent or peak output of the electric drive machine 8.

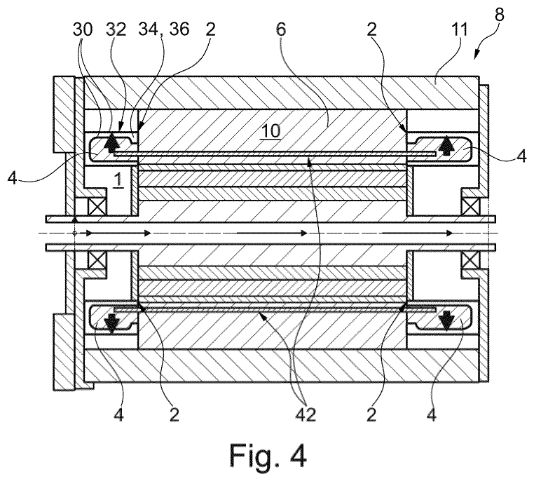

Shown in FIG. 4 is a further example of an active part cooling assembly 40, in which heat pipes 42 are additionally inserted into the stator (active part 6) in order to transmit the heat of the active part core 10 into the cavity cooling volume 34, where the heat can be discharged by the circulating cooling fluid.

### LIST OF REFERENCE SIGNS

Environment of the cooling ring 1
Cooling ring 2
Winding head 4
Active part (=stator) 6
Electric drive machine 8
Active part core (=stator core) 10
Motor housing 11
(Stator) windings 12
Production mold 20
Groove 22
External contour 24
Original wall material 26
Seal 28
Temperature control system 29
Wall 30
Plastics material casing component 32
Cavity cooling volume 34
Winding head cooling duct 36
Active part cooling assembly 40
Heat pipe 42
Rotation axes A1, A2
Method steps Sxx

1-15. (canceled)

16. A cooling ring for a winding head of an active part of an electric drive machine of a motor vehicle, comprising:
a cavity cooling volume which encloses the winding head; and
a plastics material casing component which forms a winding head cooling duct that seals the cavity cooling volume in relation to the winding head and in relation to an environment of the winding head.

17. The cooling ring according to claim 16,
wherein the plastics material casing component forms an entire wall of the winding head cooling duct.

18. The cooling ring according to claim 16,
wherein the plastics material casing component is formed integrally by a rotational molding method.

19. The cooling ring according to claim 16,
wherein the cavity cooling volume contains at least one bounding geometry of the winding head in terms of a circumferential direction and a longitudinal axis of the active part.

20. The cooling ring according to claim 16,
wherein the cooling volume extends beyond an overall extent of the winding head by part of this extent in a radial direction of the active part toward an inside and/or an outside by at least 5%, and/or in an axial direction of the active part away from an active part core by at least 25%.

21. The cooling ring according to claim 16,
wherein an active part core-proximal wall of the cooling ring is formed on an appendage of the windings of the winding head on an active part core.

22. The cooling ring according to claim 16,
wherein an active part core-proximal part of a wall of the cooling ring for heat transmission is thermally connected to an axial lateral wall of the active part core.

23. An active part cooling assembly for an electric drive machine of a motor vehicle, comprising:
an active part having an active part core and, on both sides of the active part core, in each case, one winding head which extends so as to proceed from the active part core; and
the cooling ring according to claim 16 on at least one of the winding heads.

24. The active part cooling assembly according to claim 23, comprising:
a heat pipe that extends in the active part core and in the cooling ring, and is thermally connected to the active part core and the cooling ring for heat transmission.

25. A method for producing a cooling ring for a winding head of an active part of an electric drive machine of a motor vehicle, wherein the cooling ring includes a cavity cooling volume which encloses the winding head, and a plastics material casing component which forms a winding head cooling duct that seals the cavity cooling volume in relation to the winding head and in relation to an environment of the winding head, the method comprising:
producing a wall of the plastics material casing component, which delimits the cavity cooling volume that surrounds the winding head, using a rotational molding method.

26. The method according to claim 25, comprising:
attaching a production mold, which has a groove in a shape of an envisaged external contour of the cooling ring and contains an original wall material, over the winding head to an axial lateral wall of a core of the active part.

27. The method according to claim 26,
wherein the production mold has a seal for locally delimiting the original wall material in the groove, and/or wherein the production mold is shaped in such a manner that the original wall material used for rotational molding does not flow out of the groove of the production mold and not into a stator groove.

28. The method according to claim 25, comprising:
controlling a temperature of the production mold using a temperature control system before, during and/or after rotational molding.

29. The method according to claim 25,
wherein the original wall material is a thermoplastic material and is heated in the production mold before and/or during rotational molding.

30. The method according to claim 25, comprising:
wherein the production mold attached to the active part, conjointly with the active part, is rotated successively or simultaneously about two or more rotation axes and/or agitated along at least one spatial axis during rotational molding.
